(19) United States
(12) Patent Application Publication
(10) Pub. No.: US 2019/0095813 A1
(43) Pub. Date: Mar. 28, 2019

(54) EVENT IMPORTANCE ESTIMATION

(71) Applicant: Intel Corporation, Santa Clara, CA (US)

(72) Inventors: Omri Mendels, Tel Aviv (IL); Alex Rapoport, Moshav Tal Shahar (IL); Eli Skoran, Herzelya Z (IL); Doron Shlezinger, Zichron Yaakov Z (IL)

(21) Appl. No.: 15/714,667

(22) Filed: Sep. 25, 2017

(51) Int. Cl. G06N 99/00

(52) U.S. Cl. CPC G06N 99/005; G06Q 10/1095

(57) ABSTRACT

Various systems and methods for evaluating event importance are described herein. A system for evaluating event importance includes a processor subsystem; and a memory coupled to the processor subsystem, the memory including instructions, which when executed by the processor subsystem, cause the processor subsystem to: access data related to a prior event attended by a user; access data related to an upcoming event; and use the data related to the prior event and the data related to the upcoming event in a machine learning subsystem to determine an importance score of the upcoming event.

### TECHNICAL FIELD

Embodiments described herein generally relate to appointment and calendar systems, and in particular, to systems and methods for event importance estimation.

### BACKGROUND

In a busy corporate world, people are often involved in several meetings or events throughout a given business day. In addition, people are often involved in other events, both personal and professional, that also are scheduled on their calendars. In some cases multiple events conflict resulting in double or even triple booking at a particular time slot.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a block diagram illustrating a model building process, according to an embodiment;

FIG. 2 is a diagram illustrating the inputs and processing of previous behavior, according to an embodiment;

FIG. 3 is a graph illustrating attribute collectors and event time, according to an embodiment;

FIG. 4 is a scatter plot illustrating clustering based on various attributes, according to an embodiment;

FIG. 5 is a diagram illustrating the inputs and processing of current and future states, according to an embodiment;

FIG. 6 is a flowchart illustrating a method of evaluating event importance, according to an embodiment; and

FIG. 7 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Disclosed herein are systems and methods that provide an event schedule optimizer system that provides the user indications of event importance and provides users additional information based on the event importance. Many users of mobile and wearable devices use calendar and personal assistance apps in order to plan their day ahead of time. However, users may encounter cases in which there are too many appointments, tasks, or events and therefore not be able to plan their day in an optimal manner.

With the emergence of mobile and wearable devices, new functionality has become more readily available. Many devices include sophisticated processors, radios, and other circuitry that provide notifications, location tracking, and near real time communications. Such functionality may be leveraged for appointment analysis. Through various device location services, e.g., via WiFi, Global Positioning System (GPS), and cellular communication, the user's current location and movement may be inferred from the user's mobile or wearable device. With this information, the user may be provided valuable information about their daily schedule.

The systems and methods described herein analyze outstanding events in the user's daily agenda, aiming to provide insights at a real-time perceived quality. Events include meetings, conferences, birthday parties, athletic games, social gatherings, and other occasions that may be scheduled on a calendar, event planner, or similar system.

The foundation of the mechanism is to learn the importance of each event by analyzing data on an event layer, a user layer, and their combination. The importance evaluation is based on the calendar event data combined with the assessment of attendance in previous events as a predictor for importance. In a later phase, calendar metadata and other factors that may indicate the importance of a future events are used. For example, the module may use data such as: calendar events metadata, actions and activity during events, proximity to other devices or users, user location (outdoor and indoor), to-do lists, interaction with contacts, mode of transport, previous user behavior such as visitation patterns, or motion before, during, or after events.

The event importance model is a trained machine learning model that is used to associate different factors to the importance of an event. The model is based on explicit and implicit labels, such as request for reminders, snoozing, event attendance and offline user surveys. With the described input sources and following a training phase of the model, it is possible to determine that some events are more important than others, and for which events it is important to provide proactive notifications and information to the user.

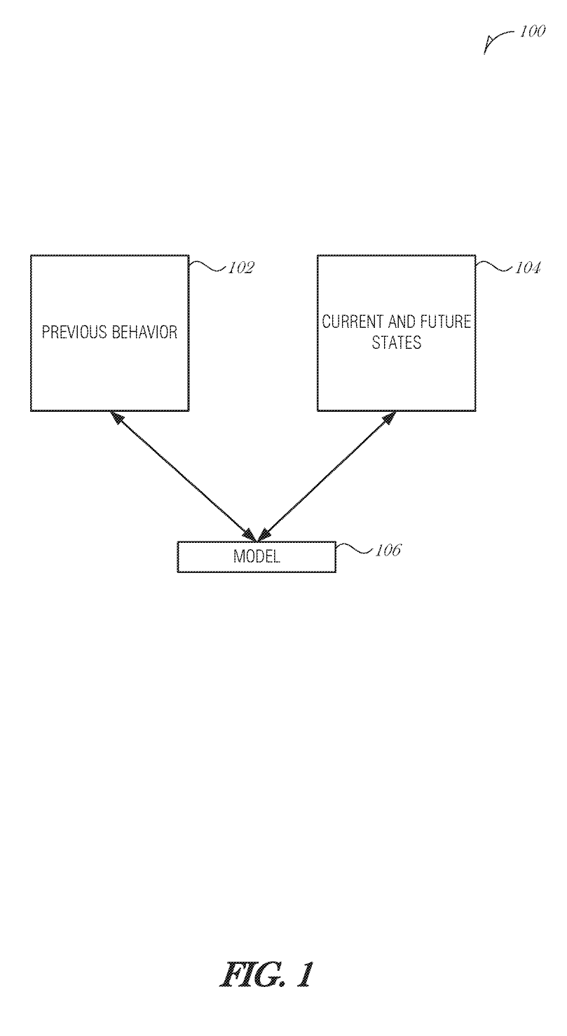

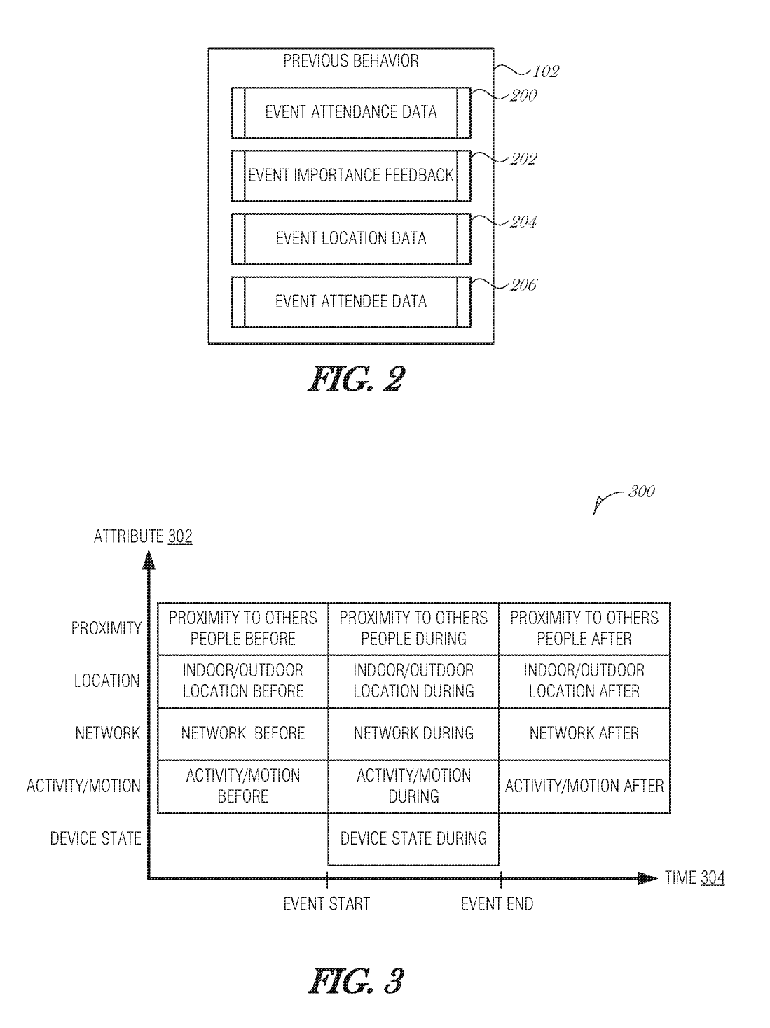

FIG. 1 is a block diagram illustrating a model building process 100, according to an embodiment. The process 100 takes previous behavior 102 and current and future states 104 as inputs, and outputs an event importance model 106. The previous behavior 102 includes facets that describe the user's behavior in previous event contexts. The process 100 uses the past behavior in order to estimate an importance of a future event. The previous behavior 102 may include aspects such as attendance, perceived importance, event location, event attendees, and the like. The aspects of previous behavior 102 are described more fully in FIGS. 2-4.

The current and future states 104 may include information about an event that the user is presently attending, an event that scheduled to occur in the future, or an event that is yet to be schedules (e.g., still in planning stages). Aspects of the current and futures states 104 include calendar metadata, likelihood of attendance, identities and relationships with attendees, current user location, and the like. The aspects of current and future states 104 are described more fully in FIG. 5.

Based on the previous behavior 102 and current and future states 104, the process 100 outputs the model 106 that predicts the event's importance and assigns it a score. Based on the score, a user interface may provide the user insight into whether to attend an event, when to leave for an event, and other information about an event.

FIG. 2 is a diagram illustrating the inputs and processing of previous behavior 102, according to an embodiment. The previous behavior 102 includes event attendance data 200, event importance feedback 202, user movement data 204, and event attendee data 206.

Event attendance data 200 represents whether the user did or did not attend an event on his schedule. Determining whether the user attended a particular event includes analyzing various aspects of the user and the event. For instance, using a mobile device that is worn or carried by the user, the user's motion, location, proximity to the event location, or device usage may be captured or obtained. The user's motion or location before, during, and after the event may be obtained. The user's proximity to other attendees, proximity to the event's location, proximity to a device used at the event, or other proximity information may be obtained. In addition, device used, such as whether the device was used to take a phone call, execute an application, disabled, or other device state or usage information may be obtained. These types of data may be used then to determine whether the user attended the event.

FIG. 3 is a graph 300 illustrating attribute collectors and event time, according to an embodiment. The graph 300 includes an attribute axis 302 and an event timeline axis 304. The attribute axis 302 includes various factors that may be used to determine user behavior, location, and other information before, during, and after the event.

The various factors illustrated on the attribute axis 302, which may include more or fewer factors, are used to assess whether the user attended the event. The factors may be obtained using electronic devices (e.g., a cellular phone, environmental sensors, network monitors, etc.). Each factor may be collected by a corresponding collector agent. Each attribute collector agent creates an attribute set based on its source. For example, a location collector agent may collect attributes related to the location of the user and attendees over time. Location may be obtained or determined by using Wi-Fi access points to track a user's mobile device, and therefore the user's location, as the user moves thorough an area covered by wireless networks. The Wi-Fi collector agent may obtain a mobile device's location and detect changes in user location using Wi-Fi routers BSSIDs and infer that the user moved to a different part of the building, a behavior that may indicate walking to a meeting.

A proximity collector agent may inspect changes in the proximity of the user to other devices, and especially to other participants on the same event (if applicable).

An activity collector agent may determine or infer the user's activity before, during, and after the event. Example activities include, but are not limited to driving, walking, talking on a phone call, exercising, and the like. The location and activity collector agents may indicate that the user was driving and arrived at a new location towards the time of the event. Changes in motion such as switching from sitting to walking and back to sitting may also indicate attendance in a meeting.

A device state collector agent may indicate that the user was on a phone call during the event, which may indicate an online event. Other device state information may be collected and used, such as whether the device was put in a sleep or low-power mode, whether the device was muted or put in a silent alarm mode, or whether certain applications were used on the device (e.g., a teleconference application).

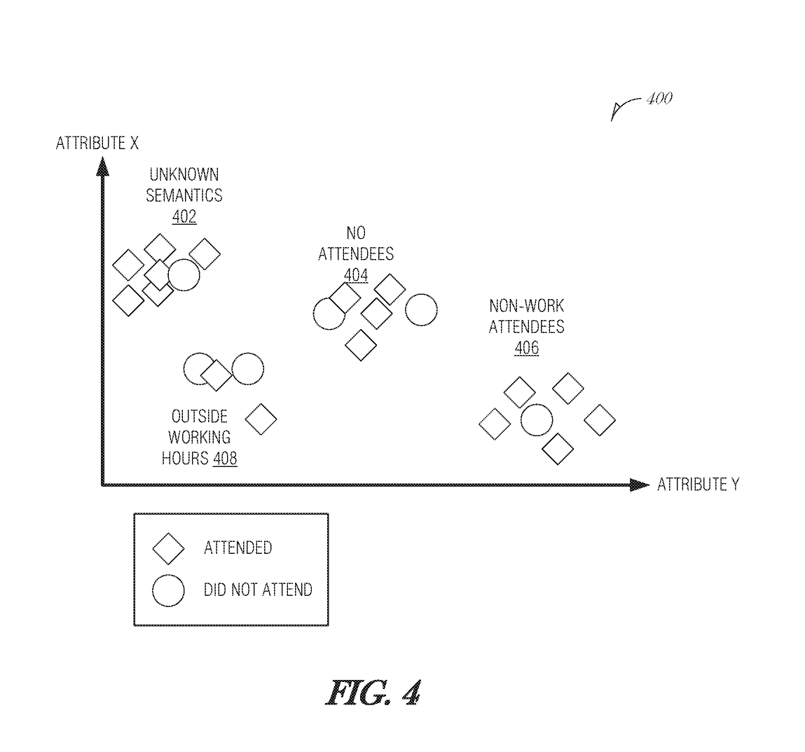

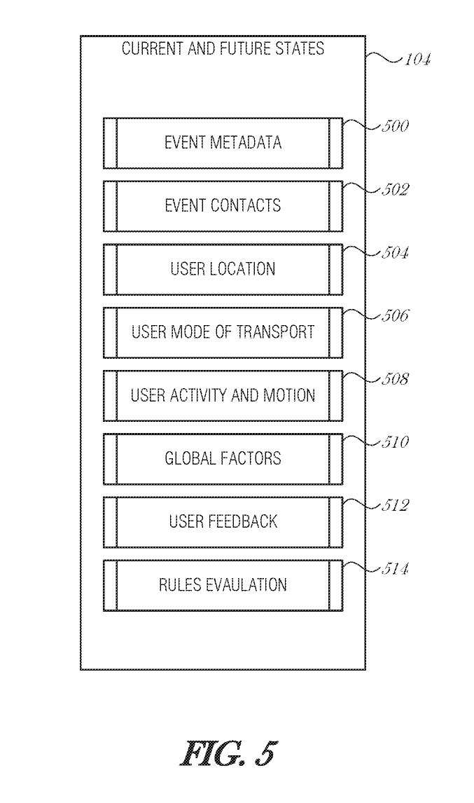

FIG. 4 is a scatter plot 400 illustrating clustering based on various attributes, according to an embodiment. The clustering helps in predicting the attendance of a future event given its attributes. Example attributes include, but are not limited to work-related meeting, meetings with a supervisor, meeting with unknown participants, events outside of working hours, personal events, non-work attendees, and other attributes or categories that may be inferred from collected data.

The scatter plot 400 illustrates various clusters, including a group of events with unknown semantics 402, a group of events with no attendees 404, a group of meetings with non-work attendees 406, and a group of events that occurred outside of working hours 408. The attendance routine of each group 402-408 is estimated and serves as a prior probability for a new event of a similar category.

Returning to the discussion of FIG. 2, event importance feedback 202 includes a complementary model that attempts to predict the importance of the event. The model estimates the importance of an “outlier” event to the user, especially an event that has no significant associated behavior pattern. The model uses implicit and explicit data from the user to determine importance of a previous event. The implicit data may be based on attendance, such as with respect to event attendance data 200, for example. Explicit data may include a user query and response to obtain the user's impression of the importance of the event. A rule system may be used to estimate importance based on implicit and/or explicit data.

User movement data 204 refers to where the user was before, during, and after an event. This location data may be obtained from event attendance data 200, for example, or from other sources, such as a meeting calendar, social media posts, or the like. Using user movement data 204 the system is able to determine whether a user is likely to attend a future event. For instance, based on past user movement data, if the user is likely to be at work during an upcoming event time, then the event may be assigned a different importance than a meeting that occurs at the workplace. The system may analyze the user's past stays at different places in order to determine statistics on whether the user is likely to arrive, leave, or be at a certain place during a future event. If an event is scheduled to occur at a place that the user is not typically at or near, then the event may be an outlier and have more significance to the user than a routine weekly meeting at work, for example.

Event attendee data 206 relates to who has attended past events. Analyzing the event attendees and cross-referencing them with the user's contacts, events that were attended by more people from the user's contacts may indicate a higher importance of the event. Conversely, events that had fewer people from the user's contacts may indicate a lower importance. It is understood that this may be inverted based on the contextual data. For instance, an event with no or few people from the user's contact list may be important because it was a meet-and-greet where the user was able to form valuable business relationships.

FIG. 5 is a diagram illustrating the inputs and processing of current and future states 104, according to an embodiment. The current and future states 104 includes event metadata 500, event contacts 502, user location 504, user mode of transport 506, user activity and motion 508, global factors 510, user feedback 512, and rules evaluation 514.

Event metadata 500 refers to data about the event, such as the subject or title of the event, attendees, number of attendees, level of familiarity with attendees, recurrence of event, location, weekday of event, and the like. The irregularity or uniqueness of the event may indicate that an event is more important. Thus, when analyzing the various metadata of an event, such as the subject or title of an event, the more unique the keywords used in the event title, the more unique the event is considered.

Event contacts 502 refers to the social distance between the user and an attendee at the event. Social distance may be based on a contacts graph, which represent each person as a node, including the user as a node in the graph. Edges between nodes may indicate a direct relationship between contacts. Thus, a person who is three edges away may be considered less familiar than a person who is only one edge away.

Familiarity may also be based, at least in part, on how often the user and an attendee attend the same events. This may be based on reviewing the user's calendar and the attendee's calendar, or by reviewing location data obtained from each of their devices, or with other analysis.

User location 504 refers to the user's travel routine and the likelihood of a user attending an event. For instance, if the event is scheduled at a routine place, such as a home or office or a commonly-visited out-of-town business place, then the user may be more likely to attend than when the event is scheduled at remote place or a non-routine place.

User mode of transport 506 refers to the user's current mode of transport (e.g., car, walking, public transportation, etc.), and the estimated time of arrival to the event location. If the user is not likely to arrive before the beginning of the event, then the user is less likely to be attending that event.

User activity and motion 508 refers to the user's current activity or motion. The user's current activity may be similar or the closely related to the user's mode of transport 506. For instance, the user may be driving and as such, the mode of transport is a passenger vehicle. As another example, the user may be walking, which is both an activity and a mode of transport. The user's current activity and motion 508 may be used to determine whether the user is likely to be able to attend the event. For instance, if the user is presently asleep and the event starts in ten minutes, then the user is not likely to attend the event.

Global factors 510 include things that may affect an event, such as weather, holidays, special events, and the like. Based on national or local weather, holidays, news, or other events, the system may adjust the likelihood that the scheduled event will occur. For instance, if the event is a weekly meeting and a Federal holiday occurs on the same day as the weekly meeting, then the likelihood that the event will occur is fairly low.

User feedback 512 incudes a feedback from a user about whether the prospective event will occur. For instance, the user's knowledge of whether the event may be canceled or not may be used to adjust the likelihood that the event will occur. Additionally, user feedback 512 may be used to adjust the importance of the event.

Rules evaluation 514 may be used to increase or decrease the importance of an event. Rules may augment machine learning or other automated mechanisms that are used to classify an event's importance.

Referring back to FIG. 1, a model 106 is constructed by fusing data from user behavioral routines, current state, and meeting information in order to derive an accurate prediction of an event's importance score. The model 106 employs the current user's state in order to decide whether the user is likely to go to an event, whether the user needs to be informed of this event, and when such notification should be presented. Mainly, the model 106 looks at the each of the event's metadata, in addition to the user's location, mode of transport, activity, and more, when making this determination. For example, if the user is away on vacation, events are likely to have different importance than when around the office. In addition, if the user has a meeting very early in the morning (before he/she usually arrives to work), it may be advisable to provide a notification the night before.

The meeting importance model 106 also learns online from user feedback. If the user did not attend a meeting with a high importance score, or did attend a meeting that the model 106 did not output as an important one, the model 106 adjusts itself.

The model 106 may be used to control one or more user interfaces. For instance, when an event is determined to be high importance, then the user may be notified of the event. This notification may take precedence over other events that are happening at the same time or close to the same time as the event. The user may be notified using a non-standard alert, which may be selected to be associated with a high-importance event. The user may set alerts using user preferences and the like. Various filters may be used in the user interface to filter out lower-importance events. Additional notifications may be used, such as guided notifications. The user's device (e.g., a mobile phone or a wearable wrist device) may alert the user that a high-importance event is occurring soon and that the user should leave their current location to travel to the event. The user device may inform the user of the quickest way to travel to the event, which mode of travel or route to use, and other pertinent information for getting to the event in time.

As user data is collected for a large number of users, trends may be observed such that certain types of events, events that happen on certain days or at certain times, or events that have certain metadata may be recognized as important events. With this model of a larger population, the system may infer that similar events that the user is or may be scheduled for will have the same or similar importance. The system may then flag such events for the user. User feedback may be used to revise the importance level of an event, which may be fed back into a global population model.

The user may also have a local personalized model. This model may be used in combination with a larger population model, or independent of a larger model. The local model may be used in the larger population model to reinforce certain information or results identified in the larger population model.

In general, the system may identify an important meeting as one that is an outlier of other routine or regular events (e.g., meetings). An outlier is a strong indication that the meeting is important. By analyzing the various factors discussed herein, the system is able to determine regular or routine events and then discern outlier events. Various machine learning methodologies may be used to classify events, identifier outlier, cluster data for further stratification, and the like. Example machine learning techniques include supervised or unsupervised learning (e.g., for classification, regression, or anomaly detection), reinforcement learning, support vector machine, neural network, boosted decision tree, decision jungle, linear regression, Bayesian linear regression, logistic regression, K-means clustering, PCA-based anomaly detection, and the like.

The previous sections have discussed various mechanisms to evaluate event importance. There are two primary factors when performing such a determination: 1) aspects of the current event under evaluation and 2) aspects of prior events. By looking at the current event, the mechanisms attempt to estimate whether the current event is unusual in some manner (e.g., special event, non-routine location, etc.). When the current event is unusual or an outlier, is usually infers that the event is important in some way. Analyzing past events provides insight into how the user acted with respect to these events. Attendance is an important factor when looking at prior events. Attendance along with other aspects of prior events (e.g., attendees, time, date, recurrence, etc.) may signal whether the current event that is being evaluated is more or less likely to be important to the user.

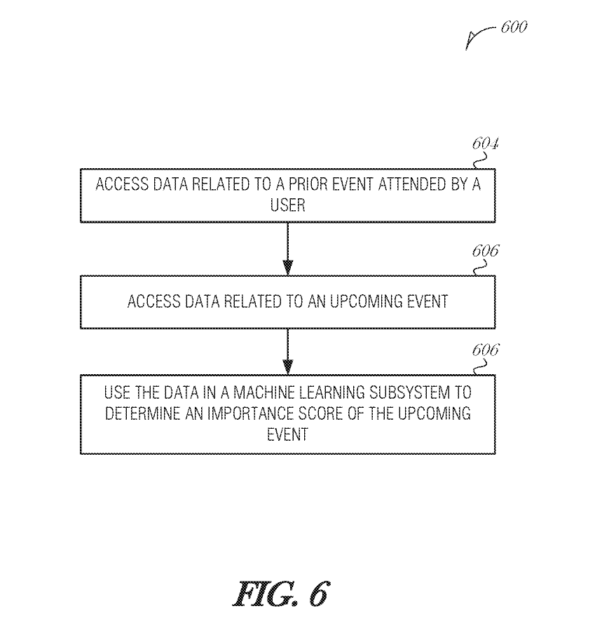

FIG. 6 is a flowchart illustrating a method 600 of evaluating event importance, according to an embodiment. At 602, data related to a prior event attended by a user is accessed at a processor subsystem. In an embodiment, the data related to the prior event comprises event attendance data. In a further embodiment, the event attendance data includes data collected using a mobile device operated by an attendee at the prior event. In a further embodiment, the mobile device comprises a cellular phone.

In a related embodiment, the data collected using the mobile device comprises location data. In a further embodiment, when the location data corresponds with a location of the prior event, the event attendance data includes an indication that the attendee likely attended the prior event.

In an embodiment, the data collected using the mobile device comprises sleep mode state data. In a further embodiment, when the sleep mode state data indicates that the mobile device was asleep during at least a portion of the prior event, the event attendance data includes an indication that the attendee likely attended the prior event.

In an embodiment, the data collected using the mobile device comprises application execution state data. In a further embodiment, when the application execution state data indicates that a teleconference application was executing during at least a portion of the prior event, the event attendance data includes an indication that the attendee likely attended the prior event.

In an embodiment, the data related to the prior event comprises event importance feedback. In an embodiment, the data related to the prior event comprises event location data. In an embodiment, the data related to the prior event comprises event attendee data.

At 604, data related to an upcoming event is accessed at the processor subsystem. In an embodiment, the data related to the upcoming event comprises event metadata. In a further embodiment, the event metadata indicates that the upcoming event is an unusual event. In a related embodiment, the event metadata includes a title containing keywords, the keywords indicating that the upcoming event is an unusual event. In a related embodiment, the event metadata includes attendees data, the attendees data indicating that the upcoming event is an unusual event.

In an embodiment, the data related to the upcoming event comprises event contacts. In an embodiment, the data related to the upcoming event comprises user location. In an embodiment, the data related to the upcoming event comprises user mode of transport. In an embodiment, the data related to the upcoming event comprises user activity and motion. In an embodiment, the data related to the upcoming event comprises global factors. In an embodiment, the data related to the upcoming event comprises user feedback. In an embodiment, the data related to the upcoming event comprises rules evaluation.

At 606, the data related to the prior event and the data related to the upcoming event is used in a machine learning subsystem to determine an importance score of the upcoming event. In an embodiment, the machine learning subsystem implements a classification routine.

In an embodiment, the machine learning subsystem comprises a programmable logic device. In a further embodiment, the programmable logic device comprises a field-programmable gate array. In a related embodiment, the programmable logic device comprises an application-specific integrated circuit.

In an embodiment, using the data related to the prior event and the data related to the upcoming event in the machine learning subsystem to determine the importance score of the upcoming event includes clustering a plurality of prior events on varying attributes and whether the user attended the plurality of prior events, into a plurality of clusters. In a further embodiment, the clustering is used to identify an attendance routine of the user amongst the plurality of clusters, the method 600 including using the attendance routine to determine whether the user is likely to attend the upcoming event.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

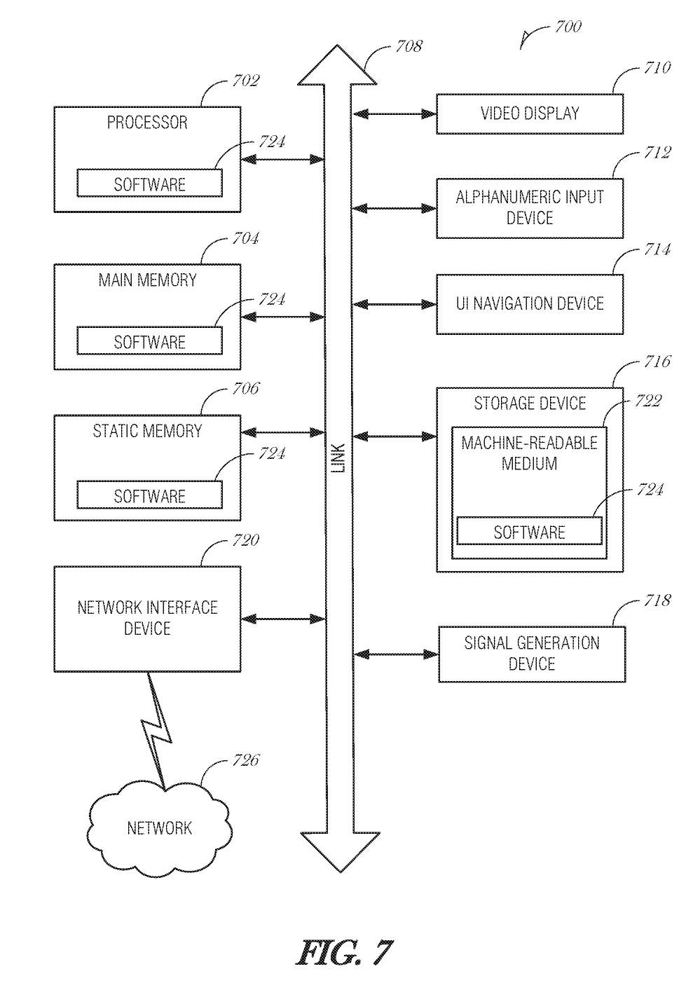

FIG. 7 is a block diagram illustrating a machine in the example form of a computer system 700, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a head-mounted display, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 700 includes at least one processor 702 (e.g., a central processing unit (CPU), a graphics processing unit (GPU) or both, processor cores, compute nodes, etc.), a main memory 704 and a static memory 706, which communicate with each other via a link 708 (e.g., bus). The computer system 700 may further include a video display unit 710, an alphanumeric input device 712 (e.g., a keyboard), and a user interface (UI) navigation device 714 (e.g., a mouse). In one embodiment, the video display unit 710, input device 712 and UI navigation device 714 are incorporated into a touch screen display. The computer system 700 may additionally include a storage device 716 (e.g., a drive unit), a signal generation device 718 (e.g., a speaker), a network interface device 720, and one or more sensors (not shown), such as a global positioning system (GPS) sensor, compass, accelerometer, gyrometer, magnetometer, or other sensor.

The storage device 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704, static memory 706, and/or within the processor 702 during execution thereof by the computer system 700, with the main memory 704, static memory 706, and the processor 702 also constituting machine-readable media.

While the machine-readable medium 722 is illustrated in an example embodiment to be a single medium, the term “machine-readable medium” may include a single medium or multiple media (e.g., a centralized or distributed database, and/or associated caches and servers) that store the one or more instructions 724. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 is a system for evaluating event importance, the system comprising: a processor subsystem; and a memory coupled to the processor subsystem, the memory including instructions, which when executed by the processor subsystem, cause the processor subsystem to: access data related to a prior event attended by a user; access data related to an upcoming event; and use the data related to the prior event and the data related to the upcoming event in a machine learning subsystem to determine an importance score of the upcoming event.

In Example 2, the subject matter of Example 1 optionally includes wherein the data related to the prior event comprises event attendance data.

In Example 3, the subject matter of Example 2 optionally includes wherein the event attendance data includes data collected using a mobile device operated by an attendee at the prior event.

In Example 4, the subject matter of Example 3 optionally includes wherein the mobile device comprises a cellular phone.

In Example 5, the subject matter of any one or more of Examples 3-4 optionally include wherein the data collected using the mobile device comprises location data.

In Example 6, the subject matter of Example 5 optionally includes wherein when the location data corresponds with a location of the prior event, the event attendance data includes an indication that the attendee likely attended the prior event.

In Example 7, the subject matter of any one or more of Examples 3-6 optionally include wherein the data collected using the mobile device comprises sleep mode state data.

In Example 8, the subject matter of Example 7 optionally includes wherein when the sleep mode state data indicates that the mobile device was asleep during at least a portion of the prior event, the event attendance data includes an indication that the attendee likely attended the prior event.

In Example 9, the subject matter of any one or more of Examples 3-8 optionally include wherein the data collected using the mobile device comprises application execution state data.

In Example 10, the subject matter of Example 9 optionally includes wherein when the application execution state data indicates that a teleconference application was executing during at least a portion of the prior event, the event attendance data includes an indication that the attendee likely attended the prior event.

In Example 11, the subject matter of any one or more of Examples 1-10 optionally include wherein the data related to the prior event comprises event importance feedback.

In Example 12, the subject matter of any one or more of Examples 1-11 optionally include wherein the data related to the prior event comprises event location data.

In Example 13, the subject matter of any one or more of Examples 1-12 optionally include wherein the data related to the prior event comprises event attendee data.

In Example 14, the subject matter of any one or more of Examples 1-13 optionally include wherein the data related to the upcoming event comprises event metadata.

In Example 15, the subject matter of Example 14 optionally includes wherein the event metadata indicates that the upcoming event is an unusual event.

In Example 16, the subject matter of any one or more of Examples 14-15 optionally include wherein the event metadata includes a title containing keywords, the keywords indicating that the upcoming event is an unusual event.

In Example 17, the subject matter of any one or more of Examples 14-16 optionally include wherein the event metadata includes attendees data, the attendees data indicating that the upcoming event is an unusual event.

In Example 18, the subject matter of any one or more of Examples 1-17 optionally include wherein the data related to the upcoming event comprises event contacts.

In Example 19, the subject matter of any one or more of Examples 1-18 optionally include wherein the data related to the upcoming event comprises user location.

In Example 20, the subject matter of any one or more of Examples 1-19 optionally include wherein the data related to the upcoming event comprises user mode of transport.

In Example 21, the subject matter of any one or more of Examples 1-20 optionally include wherein the data related to the upcoming event comprises user activity and motion.

In Example 22, the subject matter of any one or more of Examples 1-21 optionally include wherein the data related to the upcoming event comprises global factors.

In Example 23, the subject matter of any one or more of Examples 1-22 optionally include wherein the data related to the upcoming event comprises user feedback.

In Example 24, the subject matter of any one or more of Examples 1-23 optionally include wherein the data related to the upcoming event comprises rules evaluation.

In Example 25, the subject matter of any one or more of Examples 1-24 optionally include wherein to use the data related to the prior event and the data related to the upcoming event in the machine learning subsystem to determine the importance score of the upcoming event, the processor subsystem is to: cluster a plurality of prior events on varying attributes and whether the user attended the plurality of prior events, into a plurality of clusters.

In Example 26, the subject matter of Example 25 optionally includes wherein the clustering is used to identify an attendance routine of the user amongst the plurality of clusters, and the processor subsystem is to: use the attendance routine to determine whether the user is likely to attend the upcoming event.

In Example 27, the subject matter of any one or more of Examples 1-26 optionally include wherein the machine learning subsystem implements a classification routine.

In Example 28, the subject matter of any one or more of Examples 1-27 optionally include wherein the machine learning subsystem comprises a programmable logic device.

In Example 29, the subject matter of Example 28 optionally includes wherein the programmable logic device comprises a field-programmable gate array.

In Example 30, the subject matter of any one or more of Examples 28-29 optionally include wherein the programmable logic device comprises an application-specific integrated circuit.

Example 31 is a method of evaluating event importance, the method comprising: accessing, at a processor subsystem, data related to a prior event attended by a user; accessing, at the processor subsystem, data related to an upcoming event; and using the data related to the prior event and the data related to the upcoming event in a machine learning subsystem to determine an importance score of the upcoming event.

In Example 32, the subject matter of Example 31 optionally includes wherein the data related to the prior event comprises event attendance data.

In Example 33, the subject matter of Example 32 optionally includes wherein the event attendance data includes data collected using a mobile device operated by an attendee at the prior event.

In Example 34, the subject matter of Example 33 optionally includes wherein the mobile device comprises a cellular phone.

In Example 35, the subject matter of any one or more of Examples 33-34 optionally include wherein the data collected using the mobile device comprises location data.

In Example 36, the subject matter of Example 35 optionally includes wherein when the location data corresponds with a location of the prior event, the event attendance data includes an indication that the attendee likely attended the prior event.

In Example 37, the subject matter of any one or more of Examples 33-36 optionally include wherein the data collected using the mobile device comprises sleep mode state data.

In Example 38, the subject matter of Example 37 optionally includes wherein when the sleep mode state data indicates that the mobile device was asleep during at least a portion of the prior event, the event attendance data includes an indication that the attendee likely attended the prior event.

In Example 39, the subject matter of any one or more of Examples 33-38 optionally include wherein the data collected using the mobile device comprises application execution state data.

In Example 40, the subject matter of Example 39 optionally includes wherein when the application execution state data indicates that a teleconference application was executing during at least a portion of the prior event, the event attendance data includes an indication that the attendee likely attended the prior event.

In Example 41, the subject matter of any one or more of Examples 31-40 optionally include wherein the data related to the prior event comprises event importance feedback.

In Example 42, the subject matter of any one or more of Examples 31-41 optionally include wherein the data related to the prior event comprises event location data.

In Example 43, the subject matter of any one or more of Examples 31-42 optionally include wherein the data related to the prior event comprises event attendee data.

In Example 44, the subject matter of any one or more of Examples 31-43 optionally include wherein the data related to the upcoming event comprises event metadata.

In Example 45, the subject matter of Example 44 optionally includes wherein the event metadata indicates that the upcoming event is an unusual event.

In Example 46, the subject matter of any one or more of Examples 44-45 optionally include wherein the event metadata includes a title containing keywords, the keywords indicating that the upcoming event is an unusual event.

In Example 47, the subject matter of any one or more of Examples 44-46 optionally include wherein the event metadata includes attendees data, the attendees data indicating that the upcoming event is an unusual event.

In Example 48, the subject matter of any one or more of Examples 31-47 optionally include wherein the data related to the upcoming event comprises event contacts.

In Example 49, the subject matter of any one or more of Examples 31-48 optionally include wherein the data related to the upcoming event comprises user location.

In Example 50, the subject matter of any one or more of Examples 31-49 optionally include wherein the data related to the upcoming event comprises user mode of transport.

In Example 51, the subject matter of any one or more of Examples 31-50 optionally include wherein the data related to the upcoming event comprises user activity and motion.

In Example 52, the subject matter of any one or more of Examples 31-51 optionally include wherein the data related to the upcoming event comprises global factors.

In Example 53, the subject matter of any one or more of Examples 31-52 optionally include wherein the data related to the upcoming event comprises user feedback.

In Example 54, the subject matter of any one or more of Examples 31-53 optionally include wherein the data related to the upcoming event comprises rules evaluation.

In Example 55, the subject matter of any one or more of Examples 31-54 optionally include wherein using the data related to the prior event and the data related to the upcoming event in the machine learning subsystem to determine the importance score of the upcoming event includes: clustering a plurality of prior events on varying attributes and whether the user attended the plurality of prior events, into a plurality of clusters.

In Example 56, the subject matter of Example 55 optionally includes wherein the clustering is used to identify an attendance routine of the user amongst the plurality of clusters, the method including: using the attendance routine to determine whether the user is likely to attend the upcoming event.

In Example 57, the subject matter of any one or more of Examples 31-56 optionally include wherein the machine learning subsystem implements a classification routine.

In Example 58, the subject matter of any one or more of Examples 31-57 optionally include wherein the machine learning subsystem comprises a programmable logic device.

In Example 59, the subject matter of Example 58 optionally includes wherein the programmable logic device comprises a field-programmable gate array.

In Example 60, the subject matter of any one or more of Examples 58-59 optionally include wherein the programmable logic device comprises an application-specific integrated circuit.

Example 61 is at least one machine-readable medium including instructions, which when executed by a machine, cause the machine to perform operations of any of the methods of Examples 31-60.

Example 62 is an apparatus comprising means for performing any of the methods of Examples 31-60.

Example 63 is an apparatus for evaluating event importance, the apparatus comprising: means for accessing data related to a prior event attended by a user; means for accessing data related to an upcoming event; and means for using the data related to the prior event and the data related to the upcoming event in a machine learning subsystem to determine an importance score of the upcoming event.

In Example 64, the subject matter of Example 63 optionally includes wherein the data related to the prior event comprises event attendance data.

In Example 65, the subject matter of Example 64 optionally includes wherein the event attendance data includes data collected using a mobile device operated by an attendee at the prior event.

In Example 66, the subject matter of Example 65 optionally includes wherein the mobile device comprises a cellular phone.

In Example 67, the subject matter of any one or more of Examples 65-66 optionally include wherein the data collected using the mobile device comprises location data.

In Example 68, the subject matter of Example 67 optionally includes wherein when the location data corresponds with a location of the prior event, the event attendance data includes an indication that the attendee likely attended the prior event.

In Example 69, the subject matter of any one or more of Examples 65-68 optionally include wherein the data collected using the mobile device comprises sleep mode state data.

In Example 70, the subject matter of Example 69 optionally includes wherein when the sleep mode state data indicates that the mobile device was asleep during at least a portion of the prior event, the event attendance data includes an indication that the attendee likely attended the prior event.

In Example 71, the subject matter of any one or more of Examples 65-70 optionally include wherein the data collected using the mobile device comprises application execution state data.

In Example 72, the subject matter of Example 71 optionally includes wherein when the application execution state data indicates that a teleconference application was executing during at least a portion of the prior event, the event attendance data includes an indication that the attendee likely attended the prior event.

In Example 73, the subject matter of any one or more of Examples 63-72 optionally include wherein the data related to the prior event comprises event importance feedback.

In Example 74, the subject matter of any one or more of Examples 63-73 optionally include wherein the data related to the prior event comprises event location data.

In Example 75, the subject matter of any one or more of Examples 63-74 optionally include wherein the data related to the prior event comprises event attendee data.

In Example 76, the subject matter of any one or more of Examples 63-75 optionally include wherein the data related to the upcoming event comprises event metadata.

In Example 77, the subject matter of Example 76 optionally includes wherein the event metadata indicates that the upcoming event is an unusual event.

In Example 78, the subject matter of any one or more of Examples 76-77 optionally include wherein the event metadata includes a title containing keywords, the keywords indicating that the upcoming event is an unusual event.

In Example 79, the subject matter of any one or more of Examples 76-78 optionally include wherein the event metadata includes attendees data, the attendees data indicating that the upcoming event is an unusual event.

In Example 80, the subject matter of any one or more of Examples 63-79 optionally include wherein the data related to the upcoming event comprises event contacts.

In Example 81, the subject matter of any one or more of Examples 63-80 optionally include wherein the data related to the upcoming event comprises user location.

In Example 82, the subject matter of any one or more of Examples 63-81 optionally include wherein the data related to the upcoming event comprises user mode of transport.

In Example 83, the subject matter of any one or more of Examples 63-82 optionally include wherein the data related to the upcoming event comprises user activity and motion.

In Example 84, the subject matter of any one or more of Examples 63-83 optionally include wherein the data related to the upcoming event comprises global factors.

In Example 85, the subject matter of any one or more of Examples 63-84 optionally include wherein the data related to the upcoming event comprises user feedback.

In Example 86, the subject matter of any one or more of Examples 63-85 optionally include wherein the data related to the upcoming event comprises rules evaluation.

In Example 87, the subject matter of any one or more of Examples 63-86 optionally include wherein the means for using the data related to the prior event and the data related to the upcoming event in the machine learning subsystem to determine the importance score of the upcoming event include: means for clustering a plurality of prior events on varying attributes and whether the user attended the plurality of prior events, into a plurality of clusters.

In Example 88, the subject matter of Example 87 optionally includes wherein the clustering is used to identify an attendance routine of the user amongst the plurality of clusters, the apparatus including: means for using the attendance routine to determine whether the user is likely to attend the upcoming event.

In Example 89, the subject matter of any one or more of Examples 63-88 optionally include wherein the machine learning subsystem implements a classification routine.

In Example 90, the subject matter of any one or more of Examples 63-89 optionally include wherein the machine learning subsystem comprises a programmable logic device.

In Example 91, the subject matter of Example 90 optionally includes wherein the programmable logic device comprises a field-programmable gate array.

In Example 92, the subject matter of any one or more of Examples 90-91 optionally include wherein the programmable logic device comprises an application-specific integrated circuit.

Example 93 is at least one machine-readable medium including instructions for evaluating event importance, which when executed by a machine, cause the machine to perform the operations comprising: accessing data related to a prior event attended by a user; accessing data related to an upcoming event; and using the data related to the prior event and the data related to the upcoming event in a machine learning subsystem to determine an importance score of the upcoming event.

In Example 94, the subject matter of Example 93 optionally includes wherein the data related to the prior event comprises event attendance data.

In Example 95, the subject matter of Example 94 optionally includes wherein the event attendance data includes data collected using a mobile device operated by an attendee at the prior event.

In Example 96, the subject matter of Example 95 optionally includes wherein the mobile device comprises a cellular phone.

In Example 97, the subject matter of any one or more of Examples 95-96 optionally include wherein the data collected using the mobile device comprises location data.

In Example 98, the subject matter of Example 97 optionally includes wherein when the location data corresponds with a location of the prior event, the event attendance data includes an indication that the attendee likely attended the prior event.

In Example 99, the subject matter of any one or more of Examples 95-98 optionally include wherein the data collected using the mobile device comprises sleep mode state data.

In Example 100, the subject matter of Example 99 optionally includes wherein when the sleep mode state data indicates that the mobile device was asleep during at least a portion of the prior event, the event attendance data includes an indication that the attendee likely attended the prior event.

In Example 101, the subject matter of any one or more of Examples 95-100 optionally include wherein the data collected using the mobile device comprises application execution state data.

In Example 102, the subject matter of Example 101 optionally includes wherein when the application execution state data indicates that a teleconference application was executing during at least a portion of the prior event, the event attendance data includes an indication that the attendee likely attended the prior event.

In Example 103, the subject matter of any one or more of Examples 93-102 optionally include wherein the data related to the prior event comprises event importance feedback.

In Example 104, the subject matter of any one or more of Examples 93-103 optionally include wherein the data related to the prior event comprises event location data.

In Example 105, the subject matter of any one or more of Examples 93-104 optionally include wherein the data related to the prior event comprises event attendee data.

In Example 106, the subject matter of any one or more of Examples 93-105 optionally include wherein the data related to the upcoming event comprises event metadata.

In Example 107, the subject matter of Example 106 optionally includes wherein the event metadata indicates that the upcoming event is an unusual event.

In Example 108, the subject matter of any one or more of Examples 106-107 optionally include wherein the event metadata includes a title containing keywords, the keywords indicating that the upcoming event is an unusual event.

In Example 109, the subject matter of any one or more of Examples 106-108 optionally include wherein the event metadata includes attendees data, the attendees data indicating that the upcoming event is an unusual event.

In Example 110, the subject matter of any one or more of Examples 93-109 optionally include wherein the data related to the upcoming event comprises event contacts.

In Example 111, the subject matter of any one or more of Examples 93-110 optionally include wherein the data related to the upcoming event comprises user location.

In Example 112, the subject matter of any one or more of Examples 93-111 optionally include wherein the data related to the upcoming event comprises user mode of transport.

In Example 113, the subject matter of any one or more of Examples 93-112 optionally include wherein the data related to the upcoming event comprises user activity and motion.

In Example 114, the subject matter of any one or more of Examples 93-113 optionally include wherein the data related to the upcoming event comprises global factors.

In Example 115, the subject matter of any one or more of Examples 93-114 optionally include wherein the data related to the upcoming event comprises user feedback.

In Example 116, the subject matter of any one or more of Examples 93-115 optionally include wherein the data related to the upcoming event comprises rules evaluation.

In Example 117, the subject matter of any one or more of Examples 93-116 optionally include wherein using the data related to the prior event and the data related to the upcoming event in the machine learning subsystem to determine the importance score of the upcoming event includes: clustering a plurality of prior events on varying attributes and whether the user attended the plurality of prior events, into a plurality of clusters.

In Example 118, the subject matter of Example 117 optionally includes wherein the clustering is used to identify an attendance routine of the user amongst the plurality of clusters, the at least one machine-readable medium including instructions to: use the attendance routine to determine whether the user is likely to attend the upcoming event.

In Example 119, the subject matter of any one or more of Examples 93-118 optionally include wherein the machine learning subsystem implements a classification routine.

In Example 120, the subject matter of any one or more of Examples 93-119 optionally include wherein the machine learning subsystem comprises a programmable logic device.

In Example 121, the subject matter of Example 120 optionally includes wherein the programmable logic device comprises a field-programmable gate array.

In Example 122, the subject matter of any one or more of Examples 120-121 optionally include wherein the programmable logic device comprises an application-specific integrated circuit.

Example 123 is at least one machine-readable medium including instructions, which when executed by a machine, cause the machine to perform operations of any of the operations of Examples 1-122.

Example 124 is an apparatus comprising means for performing any of the operations of Examples 1-122.

Example 125 is a system to perform the operations of any of the Examples 1-122.

Example 126 is a method to perform the operations of any of the Examples 1-122.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system for evaluating event importance, the system comprising:
a processor subsystem; and
a memory coupled to the processor subsystem, the memory including instructions, which when executed by the processor subsystem, cause the processor subsystem to:
access data related to a prior event attended by a user;
access data related to an upcoming event; and
use the data related to the prior event and the data related to the upcoming event in a machine learning subsystem to determine an importance score of the upcoming event.

2. The system of claim 1, wherein the data related to the prior event comprises event attendance data.

3. The system of claim 2, wherein the event attendance data includes data collected using a mobile device operated by an attendee at the prior event.

4. The system of claim 3, wherein the data collected using the mobile device comprises application execution state data.

5. The system of claim 4, wherein when the application execution state data indicates that a teleconference application was executing during at least a portion of the prior event, the event attendance data includes an indication that the attendee likely attended the prior event.

6. The system of claim 1, wherein the data related to the upcoming event comprises event metadata.

7. The system of claim 6, wherein the event metadata indicates that the upcoming event is an unusual event.

8. The system of claim 1, wherein to use the data related to the prior event and the data related to the upcoming event in the machine learning subsystem to determine the importance score of the upcoming event, the processor subsystem is to:
cluster a plurality of prior events on varying attributes and whether the user attended the plurality of prior events, into a plurality of clusters.

9. The system of claim 8, wherein the clustering is used to identify an attendance routine of the user amongst the plurality of clusters, and the processor subsystem is to:
use the attendance routine to determine whether the user is likely to attend the upcoming event.

10. The system of claim 1, wherein the machine learning subsystem implements a classification routine.

11. A method of evaluating event importance, the method comprising:
accessing, at a processor subsystem, data related to a prior event attended by a user;
accessing, at the processor subsystem, data related to an upcoming event; and
using the data related to the prior event and the data related to the upcoming event in a machine learning subsystem to determine an importance score of the upcoming event.

12. The method of claim 11, wherein the data related to the prior event comprises event attendance data.

13. The method of claim 12, wherein the event attendance data includes data collected using a mobile device operated by an attendee at the prior event.

14. The method of claim 13, wherein the mobile device comprises a cellular phone.

15. The method of claim 13, wherein the data collected using the mobile device comprises location data.

16. The method of claim 15, wherein when the location data corresponds with a location of the prior event, the event attendance data includes an indication that the attendee likely attended the prior event.

17. The method of claim 13, wherein the data collected using the mobile device comprises sleep mode state data.

18. The method of claim 17, wherein when the sleep mode state data indicates that the mobile device was asleep during at least a portion of the prior event, the event attendance data includes an indication that the attendee likely attended the prior event.

19. The method of claim 11, wherein using the data related to the prior event and the data related to the upcoming event in the machine learning subsystem to determine the importance score of the upcoming event includes:
clustering a plurality of prior events on varying attributes and whether the user attended the plurality of prior events, into a plurality of clusters.

20. The method of claim 19, wherein the clustering is used to identify an attendance routine of the user amongst the plurality of clusters, the method including:
using the attendance routine to determine whether the user is likely to attend the upcoming event.

21. The method of claim 11, wherein the machine learning subsystem comprises a programmable logic device.

22. At least one non-transitory machine-readable medium including instructions for evaluating event importance, which when executed by a machine, cause the machine to perform the operations comprising:
accessing data related to a prior event attended by a user;
accessing data related to an upcoming event; and
using the data related to the prior event and the data related to the upcoming event in a machine learning subsystem to determine an importance score of the upcoming event.

23. The at least one machine-readable medium of claim 22, wherein the data related to the prior event comprises event attendance data.

24. The at least one machine-readable medium of claim 22, wherein using the data related to the prior event and the data related to the upcoming event in the machine learning subsystem to determine the importance score of the upcoming event includes:
clustering a plurality of prior events on varying attributes and whether the user attended the plurality of prior events, into a plurality of clusters.

25. The at least one machine-readable medium of claim 24, wherein the clustering is used to identify an attendance routine of the user amongst the plurality of clusters, the at least one machine-readable medium including instructions to:
use the attendance routine to determine whether the user is likely to attend the upcoming event.
